(19) United States
(12) Patent Application Publication
(10) Pub. No.: US 2023/0412965 A1
(43) Pub. Date: Dec. 21, 2023

(54) APPARATUS FOR REPRODUCING SOUND AND HEADPHONE COMPRISING SAME

(71) Applicant: HARMAN INTERNATIONAL INDUSTRIES, INCORPORATED, Stamford, CT (US)

(72) Inventors: Fang LIU, Shenzhen Guangdong (CN); Tieyi LIANG, Shenzhen Guangdong (CN); Yi ZHANG, Shenzhen Guangdong (CN)

(73) Assignee: HARMAN INTERNATIONAL INDUSTRIES, INCORPORATED, Stamford, CT (US)

(21) Appl. No.: 18/334,856

(22) Filed: Jun. 14, 2023

(30) Foreign Application Priority Data
Jun. 17, 2022 (CN) 202210691386.X

(51) Int. Cl. H04R 1/10; H04R 5/033

(52) U.S. Cl. CPC H04R 1/1041; H04R 5/033; H04R 2420/07; H04S 3/008

(57) ABSTRACT

An apparatus for reproducing sound is provided. The apparatus includes an isolation switch to receive a first audio signal with reference to a first reference level and \output or isolate the first audio signal; a wireless communication component configured to receive a wireless input signal and to generate a second audio signal with reference to a second reference level based on the wireless input signal, and an audible component connected to the isolation switch and the wireless communication component, respectively, and being configured to receive, one of the first audio signal from the isolation switch or the second audio signal from the wireless communication component and to emit a sound signal based on the received audio signal so that the second audio signal and the first audio signal do not interfere with each other.

### CROSS-REFERENCE TO RELATED APPLICATIONS

This application claims priority to CN Application Serial No. 202210691386.X filed Jun. 17, 2022, the disclosure of which is hereby incorporated in its entirety by reference herein.

### TECHNICAL FIELD

The present disclosure relates to an apparatus for reproducing sound, and particularly to a headphone, specifically a stereo headphone, comprising the apparatus for reproducing sound.

### BACKGROUND

In a system for reproducing sound, one or more loudspeakers, particularly loudspeakers in two earphones of a headphone, are typically used for reproduction of desired sound such as voice or speech. Due to the variety of application scenarios of the headphone, a listener can switch between a wireless transmission mode and a wired transmission mode connected to an interface of an audio source device as needed to hear the desired sound. However, a reference level of an audio signal based on the wireless transmission mode is different from that of an audio signal based on the wired transmission mode, so that the two types of audio signals in these two modes may interfere with each other when sent to a loudspeaker terminal at the same time. This may result in the listener not being able to effectively hear the desired sound. Therefore, it is necessary to overcome mutual interference between the two types of audio signals having different reference levels, to improve the sound effect for the listener.

### SUMMARY

One aspect of the present disclosure is to provide, among other things, an apparatus for reproducing sound, which has an isolation switch to control outputs of different audio signals.

According to another aspect of the present disclosure, an apparatus for reproducing sound is provided. The apparatus includes an isolation switch configured to receive a first audio signal with reference to a first reference level and selectively output or isolate the first audio signal; a wireless communication component configured to wirelessly receive a wireless input signal and to generate and output a second audio signal with reference to a second reference level based on the wireless input signal, where the second reference level is different from the first reference level; and an audible component connected to the isolation switch and the wireless communication component, respectively, and configured to receive, based on determining a state of the isolation switch and a mode of the wireless communication component, one of the first audio signal from the isolation switch or the second audio signal from the wireless communication component and to emit a sound signal based on the received audio signal so that the second audio signal and the first audio signal do not interfere with each other.

According to one or more embodiments, that receiving, based on determining a state of the isolation switch and a mode of the wireless communication component, one of the first audio signal from the isolation switch or the second audio signal from the wireless communication component and emitting a sound signal based on the received audio signal includes: based on determining that the isolation switch is turned on and the wireless communication component is powered off, the isolation switch outputting the first signal to the audible component, the audible component receiving the first audio signal and emitting a first sound signal based on the first audio signal; and based on determining that the isolation switch is turned off and the wireless communication component is powered on, the isolation switch isolating the first audio signal and the wireless output component outputting the second audio signal to the audible component, and the audible component receiving the second audio signal and emitting a second sound signal based on the second audio signal.

According to one or more embodiments, the isolation switch is turned on when a power supply for the isolation switch is not driven, and the isolation switch is turned off when the power supply is driven.

According to one or more embodiments, the first audio signal includes one or more pairs of first audio sub-signals, each pair of the one or more pairs of first audio sub-signals having an audio signal with reference to the first reference level and a ground signal acting as the first reference level; the second audio signal includes one or more pairs of second audio sub-signals, each pair of the one or more pairs of second audio sub-signals having a positive and negative audio signal with reference to the second reference level; and the audible component includes one or more audible sub-components.

According to one or more embodiments, the isolation switch is configured as one or more two-way switches, and two ways in each of the one or more two-way switches either output a pair of first audio sub-signals to the audible sub-component corresponding to the pair of first audio sub-signals or isolate the pair of first audio sub-signals, and the one or more two-way switches either output or isolate the one or more audio sub-signals at the same time.

According to one or more embodiments, in case the first audio signal includes two pairs of first audio sub-signals, the isolation switch is configured as a four-way switch, and any two ways of the four-way switches either output a pair of first audio sub-signals to the audible sub-component corresponding to the pair of first audio sub-signals or isolate the pair of first audio sub-signals.

According to one or more embodiments, the isolation switch has a power-on duration shorter than a power-on duration of the wireless communication component.

According to one or more embodiments, the isolation switch has an isolation voltage value depending on a voltage amplitude of the first audio signal.

According to one or more embodiments, the wireless communication component is directly connected to the audible component without arranging a reference level conversion component for converting the second audio signal with reference to the second reference level to a further audio signal with reference to the first reference level.

According to another aspect of the present disclosure, a headphone is provided, including the apparatus for reproducing sound as described above.

According to various embodiments of the present disclosure, isolation of the first audio signal and the second audio signal, which have different reference levels respectively, may be achieved by arranging the isolation switch, without arranging a dedicated reference level conversion component, ensuring that the first audio signal and the second audio signal do not interfere with each other and avoiding a signal conflict. In addition, by omitting the reference level conversion component, the apparatus for reproducing sound may improve the performance of electrostatic discharge (ESD) and electromagnetic interference (EMI) of an electronic device. Lower manufacturing cost, lower background noise, smaller package size, lower power consumption and longer play time are achieved, so that a better effect of sound reproduction is achieved.

### BRIEF DESCRIPTION OF THE DRAWINGS

The aspects, features and advantages of the present disclosure will become clearer and easier to understand by the following description of embodiments in conjunction with the accompanying drawings, in which:

FIG. 1 shows a schematic block diagram of an apparatus for reproducing sound according to one or more embodiments of the present disclosure;

FIG. 2 shows a schematic block diagram of an apparatus for reproducing sound according to another one or some other embodiments of the present disclosure;

FIG. 3 shows a schematic circuit block diagram of an apparatus for reproducing sound that includes a four-way switch according to a specific embodiment of the present disclosure;

FIG. 4 shows a schematic circuit block diagram of an apparatus for reproducing sound that includes a plurality of two-way switch according to a specific embodiment of the present disclosure; and

FIG. 5 shows a schematic diagram of a headphone having an apparatus for reproducing sound according to the present disclosure.

### DETAILED DESCRIPTION

The present disclosure will be described in detail below with reference to exemplary embodiments of the present disclosure. However, the present disclosure is not limited to the embodiments described herein, and it may be implemented in many different forms. The described embodiments are merely intended to make the present disclosure thorough and complete, and to fully convey the concept of the present disclosure to those skilled in the art. The features of the various embodiments described may be combined or substituted for each other unless expressly excluded or should be excluded according to the context.

Unless otherwise defined, the technical terms or scientific terms used in the present disclosure should have well-known meanings generally understood by those skilled in the art. The terms “first”, “second”, and the like used in the present disclosure do not denote any sequence, quantity, or importance, but are merely used to distinguish different components. “include” or “comprise” and similar terms are intended to mean that the element or object appearing before this word covers the element or object appearing after the word listed and its equivalent, without excluding other elements or objects. Similar terms such as “coupling”, “connection” or “connected” are not limited to physical or mechanical connections, but may include electrical connections, whether direct or indirect. “Upper”, “lower”, “left”, “right”, and the like are merely used to indicate relative location relationship. The relative location relationship may vary with an absolute location of the described object correspondingly.

As noted herein, there are two types of audio signals with different reference levels in the wired mode and the wireless mode may interfere with each other, causing the two types of audio signals to generate noise in an audible component. Thus, in this regard, embodiments are set forth for solving the above technical problems will be described in detail below in conjunction with the accompanying drawings.

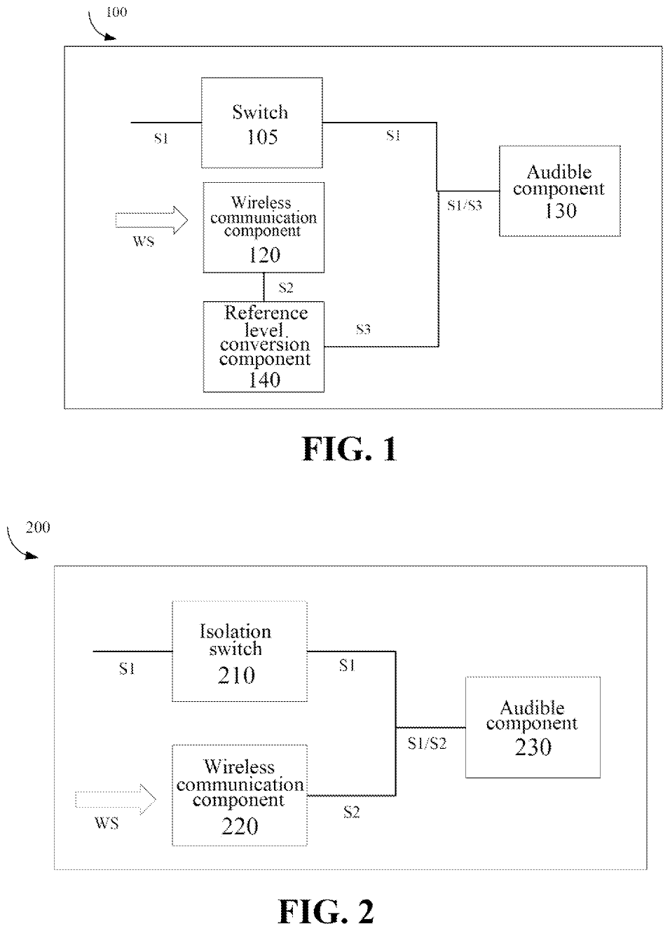

FIG. 1 shows a schematic block diagram of apparatus 100 for reproducing sound according to an embodiment of the present disclosure. As shown in FIG. 1, apparatus 100 for reproducing sound includes switch 105, wireless communication component 120, audible component 130, and reference level conversion component 140. Specifically, switch 105, wireless communication component 120, and reference level conversion component 140 are respectively located on two different signal transmission paths. In addition, switch 105, wireless communication component 120, audible component 130 and reference level conversion component 140 may be implemented in electronics, and for example, may be arranged on a control board, especially on a Printed Circuit Board (PCB), such as in an apparatus for reproducing sound of a headphone.

Switch 105 may receive a first audio signal S1 with reference to a first reference level and selectively output or isolate the first audio signal S1. For example, the first reference level may be a ground level to achieve unbalanced transmission. For example, the first audio signal S1 may come from an audio device via an audio input interface (also referred to as an AUX interface) and be in unbalanced transmission. For example, the audio input interface (not shown) may be a conventional headphone jack or headphone plug for unbalanced transmission, including, but not limited to, 6.35 mm, 3.5 mm Top Ring Sleeve (TRS), 3.5 mm Top Ring Ring Sleeve (TRRS), 2.5 mm TRRS, 4.4 mm, lightning, USB type-C, 4-pin External Line Return (XLR) and possible future plug forms. For example, the audio device (not shown) may be a cell phone, a personal digital assistant (PDA), a tablet computer, a laptop computer, an electronic audio player, a virtual reality device, a radio, or other device that enables an audio output. For example, switch 105 may output the first audio signal S1 when being connected to the audio device via the audio input interface. In another example, switch 105 may also isolate the first audio signal S1 according to the needs of a listener in the process of being connected to the audio device via the audio input interface. For example, the start of switch 105 may be based on the power-on of an input/output interface that interacts with the listener or other components in the apparatus for reproducing sound. The latter case will be described in detail below. For example, the input/output interface for interacting with the listener may be disposed on a peripheral device of the apparatus for reproducing sound or a hardware component of the audio device to interact with switch 105.

Wireless communication component 120 may be configured to wirelessly receive a wireless input signal WS and to generate and output a second audio signal S2 with reference to a second reference level based on the wireless input signal WS. The second reference level may be a level of the signal itself to achieve balanced transmission. For example, wireless communication component 120 may be a hardware component that utilizes Bluetooth transmission, such as a Bluetooth chip. For example, wireless communication component 120 may receive the wireless input signal WS from the abovementioned audio device through an antenna (not shown in the figure). For example, in the case that the wireless communication component is a Bluetooth chip, the Bluetooth chip may perform Bluetooth pairing with the audio device in advance and transmit, based on the Bluetooth transmission protocol, the wireless input signal WS for being input to the Bluetooth chip. Optionally, the peripheral hardware component with the Bluetooth chip may also be configured to send a control signal to control the audio in the audio device, such as a control signal for turning on the Bluetooth device, a control signal of play volume, a control signal of play speed, and a control signal for switching play files. For example, wireless communication component 120 generates the balanced second audio signal S2 based on the wireless input signal WS.

Reference level conversion component 140 may be connected to wireless communication component 120 and convert the balanced second audio signal S2 into an unbalanced third audio signal S3. For example, reference level conversion component 140 may be configured as a hardware component that converts an audio signal with reference to the signal itself into an audio signal with reference to a ground level. For example, reference level conversion component 140 may be an audio transformer, an operational amplifier, or other conversion components for converting a balanced audio signal into an unbalanced audio signal. Herein, the audio transformer may have high requirements on the process, material and structure of the device, resulting in a high cost in use of the audio transformer. Alternatively, the conversion component composed of the operational amplifier is simple, so that the cost is lower than that of the conversion component composed of the audio transformer.

Audible component 130 is connected to switch 105, is connected to wireless communication component 120 via reference level conversion component 140, receives, based on the control of switch 105, one of the first audio signal S1 from switch 105 and the third audio signal S3 from reference level conversion component 140, and emits a sound signal corresponding to the received audio signal, based on the received audio signal S1/S3. For example, the audible component may be an apparatus configured to convert an audio signal into a sound signal. For example, the audible component may be a loudspeaker, a horn or other apparatus that can realize electro-acoustic transduction. In the apparatus for reproducing sound 100, the third audio signal S3 is an unbalanced audio signal obtained after the balanced second audio signal is processed by reference level conversion component 140. Therefore, when wireless communication component 140 is enabled, the third audio signal is not interfered with the ground signal at the audio input interface, even if switch 105 does not have any audio signal input via the audio input interface but is still connected to the audio input interface. In other words, when the wireless communication component is enabled and technical switch 105 is turned on but there is no input of the first audio signal S1, the unbalanced third audio signal S3 may not be affected by the ground signal. However, in the foregoing case, wireless communication component 140 cannot be omitted. For example, if the second audio signal via the wireless communication component 140 is sent directly to the audible component 130, then the balanced second audio signal is significantly interfered with the ground signal noise from the audio input interface terminal. This may be the case since the third audio signal and the first audio signal are both referenced to the ground level for unbalanced transmission. In this way, noise interference is avoided. However, the second audio signal S2 is referenced to the level of the signal itself and may be a balanced audio signal. Moreover, when the second audio signal S2 changes with the ground signal and inevitably causes a conflict between different reference levels, the second audio signal S2 cannot reproduce sound clearly because the reference level is changed. In this case, the noise interference may be serious. In view of the above, switch 105 may be omitted.

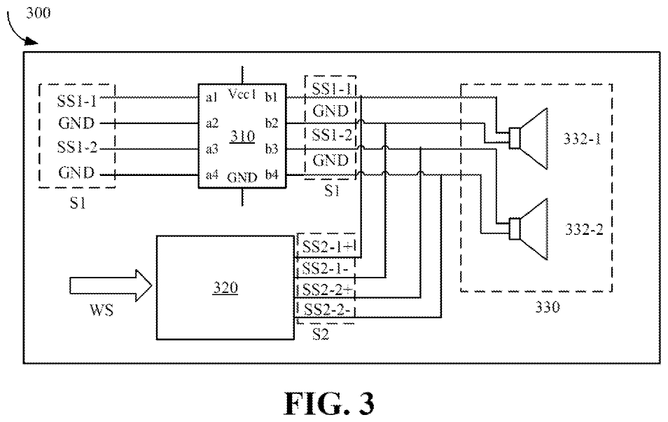

Based on the above description, it can be seen that the reference level conversion component such as the power amplifier does not need to amplify the power of an audio signal. Its only function is to convert a balanced audio signal to an unbalanced audio signal, and effectively avoid mutual conflict between unbalanced transmission and balanced transmission, especially a conflict between a ground signal or a ground terminal in the unbalanced audio signal and the balanced audio signal. Therefore, it is effective to float the balanced audio signal to avoid a connection with the ground signal. For the purpose of effectively avoiding the conflict between unbalanced audio signal and the balanced audio signal, this application further proposes specific embodiments of FIG. 2 to FIG. 4. The embodiments of FIG. 2 to FIG. 4 mainly describe another apparatus for reproducing sound, in which an improved isolation switch is used and the reference level conversion component such as the power amplifier is omitted. The improved apparatus for reproducing sound will be described in detail below with reference to FIG. 2 to FIG. 4.

FIG. 2 shows a schematic block diagram of apparatus 200 for reproducing sound according to another embodiment of the present disclosure. Apparatus 200 for reproducing sound shown in FIG. 2 may include isolation switch 210, wireless communication component 220, and audible component 230, where a first audio signal S1 and a second audio signal S2 are also illustrated. In apparatus 200 for reproducing sound, isolation switch 210 and wireless communication component 220 and the first audio signal S1 and the second audio signal S2 are the same as switch 105 and wireless communication component 120 and the first audio signal S1 and the second audio signal S2 illustrated in FIG. 1, which will not be repeated here. Particularly, the first reference level of the first audio signal S1 is different from the second reference level of the second audio signal S2.

In the apparatus for reproducing sound as shown in FIG. 2, audible component 230 is connected to isolation switch 210 and wireless communication component 220 respectively, receives, based on determining a state of isolation switch 210 and a mode of wireless communication component 220, one of the first audio signal S1 from isolation switch 210 or the second audio signal S2 from wireless communication component 220, and emits a sound signal based on the received audio signal S1/S2, so that the second audio signal S2 and the first audio signal S1 do not interfere with each other. Therefore, reference level conversion component 140 shown in FIG. 1 is not arranged between audible component 230 and wireless communication component 220. In other words, audible component 230 is directly connected to wireless communication component 220. By turning off or on the isolation switch, the first audio signal S1 and the second audio signal S2 may be output to audible component 230 in a non-interfering manner. Specifically, the state of isolation switch 210 may include a turned off state and a turned on state; the mode of wireless communication component 220 includes an active mode in which the wireless communication component is powered on and a passive mode in which the wireless communication component is powered off. The specific operation method will be described in detail below.

As described above, the first audio signal S1 with reference to the first reference level is an unbalanced audio signal, and the second audio signal S2 with reference to the second reference level is a balanced audio signal, in particular a positive/negative audio signal.

For example, based on determining that isolation switch 210 is turned on and wireless communication component 220 is powered off, isolation switch 210 outputs the first audio signal S1 to audible component 230, and audible component 230 receives the first audio signal S1 and emits a first sound signal based on the first audio signal S1. Based on determining that isolation switch 210 is turned off and wireless communication component 220 is powered off, wireless communication component 220 outputs the second audio signal S2 to audible component 230, and audible component 230 receives the second audio signal S2 and emits a second sound signal based on the second audio signal S2. For example, wireless communication component 220 being powered off may be referred to as a passive mode. That is, in the passive mode, apparatus 200 for reproducing sound may be hard-wired connected to the audio device via the audio input interface. However, wireless communication component 220 being powered on may be referred to as active mode. That is, in the active mode, apparatus 200 for reproducing sound may be wirelessly connected to the audio device via the wireless communication component. Therefore, on and off of the isolation switch is performed currently with whether the wireless communication component is powered on or off, enabling targeted isolation of the first audio signal from the second audio signal in the active mode or passive mode, to make only one of the unbalanced audio signal or the balanced audio signal sound. Therefore, compared with apparatus 100 for reproducing sound, apparatus 200 for reproducing sound may achieve lower noise, lower cost, lower power consumption, and longer play time.

For example, the on or off of isolation switch 210 is controlled based on a power source being driven. Particularly, isolation switch 210 is turned on when its power supply is not driven, and isolation switch 210 is turned off when the power supply is driven. Advantageously, when wireless communication component 220 in apparatus 200 for reproducing sound is powered on, in other words, when the power supply is driven in apparatus 200 for reproducing sound, the isolation switch may be turned off using the power generated when the wireless communication component of the apparatus 200 for reproducing sound is enabled. In this way, the wireless communication component is powered on currently with the switch is turned off, so that isolation between the two audio signals S1/S2 in different modes is achieved. Therefore, the isolation switch may be a depletion switch for realizing high-performance connection or transmission of audio signals without a power supply.

For the purpose of better isolation, isolation switch 210 has a power-on duration shorter than a power-on duration of wireless communication component 220. Preferably, isolation switch 210 has a power-on duration shorter than 150 μs, preferably shorter than 100 s, more preferably shorter than 50 s, or even shorter. Isolation switch 210 has the power-on duration significantly shorter than the power-on duration of wireless communication component 220, so that the second audio signal S2 generated by the wireless communication component is less prone to affect from the ground signal during transmission. This is because, before the second audio signal S2 is sent, isolation switch 210 has been turned off and an output terminal of wireless communication component 220 is suspended without being connected to the ground signal. Therefore, by closing of the isolation switch 210, the audio signal can be sent even when the apparatus for reproducing sound is powered off, eliminating the need for an additional load peripheral circuit to control the isolation switch. Accordingly, isolation switch 210 can send the first audio signal S1 directly during passive operation and only be turned off during active operation to isolate the ground signal.

For example, isolation switch 210 has an isolation voltage value depending on a voltage amplitude of the first audio signal. Preferably, the isolation voltage value of isolation switch 210 is slightly greater than the voltage amplitude of the first audio signal. Here, the phrase “slightly greater than” may be understood as no more than 10%, no more than 20%, preferably no more than 30% greater than the voltage amplitude of the first audio signal. For example, an isolation voltage of the isolation switch is proportional to a supply voltage of the isolation switch, where the isolation voltage value of isolation switch 210 is predefined. For example, if a predetermined supply voltage value of isolation switch 210 is 3 V, the isolation voltage value may be set to be greater than 1 Vrms; if a predetermined supply voltage value of isolation switch 210 is less than 3 V, the isolation voltage value may be less than 1 Vrms. Based on the above relationship, the supply voltage of isolation switch 210 therefore also depends on a voltage value of the audio signal to be output, realizing flexible selection of supply voltage. Compared with the reference level conversion component such as the power amplifier, isolation switch 210 has the advantages of low power consumption and low noise, and only generates power consumption when the wireless communication component is powered on.

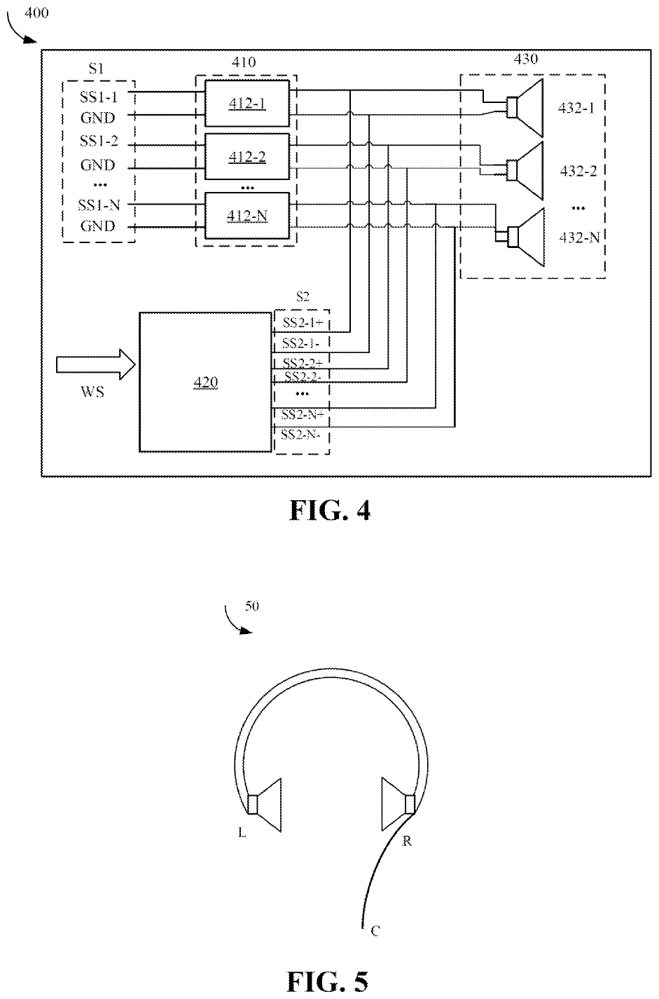

Two specific embodiments of isolation switches 310 and 410 and two schematic diagrams of apparatuses 300 and 400 for reproducing sound are described below with reference to FIG. 3 and FIG. 4.

FIG. 3 shows a schematic circuit block diagram of apparatus 300 for reproducing sound that includes four-way switch 310 according to a specific embodiment of the present disclosure. Isolation switch 310, wireless communication component 320 and audible component 330 in apparatus 300 for reproducing sound in FIG. 3 are the same as isolation switch 210, wireless communication component 220 and audible component 230 in apparatus 200 for reproducing sound in FIG. 2, which will not be repeated here.

As shown in FIG. 3, the first audio signal S1 (shown by the dashed box in FIG. 3) may include two pairs of first audio sub-signals SS1-1/GND, SS1-2/GND, each pair of the two pairs of first audio sub-signals SS1-1/GND, SS1-2/GND having audio signals SS1-1, SS1-2 with reference to the first reference level and a ground signal GND acting as the first reference level. The second audio signal S2 (shown by the dashed box in FIG. 3) includes one or more pairs of second audio sub-signals SS2-1+/SS2-1−, SS2-2+/SS2-2−, each pair of the two pairs of second audio sub-signals SS2-1+/SS2-1−, SS2-2+/SS2-2− having positive audio signals SS2-1+, SS2-2+(with positive sign, indicating a positive voltage) and negative audio signals SS2-1−, SS2-2− (with negative sign, indicating a negative voltage) with reference to the second reference level. The reference to the first reference level may be understood as using the ground level as a reference level, and the reference to the second reference level may be understood as using the audio signal itself as a reference level. Audible component 330 (shown by the dashed box in FIG. 3) includes two audible components 332-1, 332-2. For example, in the case of two pairs of first and second audio sub-signals, the audio sub-signals with suffixes of -1 and -2 may respectively refer to an audio signal of a left channel and an audio signal of a right channel. Correspondingly, audible sub-components with suffixes of -1 and -2 may respectively refer to an audible component of the left channel and an audible component of the right channel. Through the input and output of audio under pairing of the left and right channels, apparatus 300 for reproducing sound can achieve a sound reproduction effect of a stereo sound field with high musical quality.

As shown in FIG. 3, in case the first audio signal S1 may include two pairs of first audio sub-signals SS1-1/GND, SS1-2/GND, isolation switch 310 is configured as four-way switch 310, and any two ways of four-way switch 310 control a pair of first audio sub-signals SS1-1/GND or SS1-2/GND. Specifically, four-way switch 310 may have four input ports a1 to a4, a Vcc1 driving power terminal, a ground terminal GND, and four output ports b1 to b4. For example, four-way switch 310 may also be a depletion switch, as mentioned above, enabling a high-performance connection even without power supply being driven. For example, four-way switch 310 may be a 4P4T switch. Specifically, in the two pairs of first audio sub-signals SS1-1/GND, SS1-2/GND, outputs of the audio signals SS1-1, SS1-2 with reference to the ground level are connected to outputs of the positive audio signals SS2-1+, SS2-2+, respectively, and an output of the ground signal GND acting as the first reference level is connected to outputs of the negative audio signals SS2-1−, SS2-2−, respectively. With wireless communication component 320 powered off and four-way switch 310 turned on, four-way switch 310 simultaneously outputs the two pairs of first audio sub-signals SS1-1/GND, SS1-2/GND to two audible sub-components 332-1, 332-2, respectively. With wireless communication component 320 powered on and four-way switch 310 turned off, four-way switch 310 simultaneously isolates the two pairs of first audio sub-signals SS1-1/GND, SS1-2/GND, and wireless communication component 320 outputs the two pairs of second audio sub-signals SS2-1+/SS2-1−, SS2-2+/SS2-2− to two audible sub-components 332-1, 332-2, respectively. With the setting of four-way switch 310, four signals can be turned on or off simultaneously using a single component. The setting of a single switch may reduce the package size of the device and lower the element cost.

FIG. 4 shows a schematic circuit block diagram of apparatus 400 for reproducing sound that includes a plurality of two-way switches according to the present disclosure. Isolation switch 410, wireless communication component 420 and audible component 430 in apparatus 400 for reproducing sound in FIG. 4 are the same as isolation switch 210, wireless communication component 220 and audible component 230 in apparatus 200 for reproducing sound in FIG. 2, and isolation switch 310, wireless communication component 320 and audible component 330 in apparatus 300 for reproducing sound in FIG. 3, which will not be repeated here.

As shown in FIG. 4, the first audio signal S1 (shown by the dashed box in FIG. 4) may include one or more pairs of first audio sub-signals SS1-1/GND, SS1-2/GND, . . . , SS1-N/GND, where N may be an integer greater than 1. Each pair of the one or more pairs of first audio sub-signals has audio signals SS1-1, SS1-2, . . . , SS1-N with reference to the first reference level and a ground signal GND acting as the first reference level. The second audio signal S2 (shown by the dashed box in FIG. 4) includes one or more pairs of second audio sub-signals SS2-1+/SS2-1−, SS2-2+/SS2-2−, . . . , SS2-N+/SS2-N−, each pair of the one or more pairs of second audio sub-signals having positive audio signals SS2-1+, SS2-2+, . . . , SS2-N+(with positive sign) and negative audio signals SS2-1−, SS2-2−, . . . , SS2-N− (with negative sign) with reference to the second reference level. The audible component may include one or more audible sub-components 332-1, 332-2, . . . , 332-N (shown by the dashed box in FIG. 4). Similarly, as described in FIG. 3, in the case of one or more pairs of first and second audio sub-signals, audio sub-signals with suffixes -1, -2, . . . , -N may be selected from one or more of the following audio signals of a left channel, a right channel, a left front channel, a right front channel, a left rear channel, a right rear channel, a bass channel, etc. Correspondingly, audible sub-components with suffixes of -1 and -2, . . . , -N may be selected from one or more of the following audible components of a left channel, a right channel, a left front channel, a right front channel, a left rear channel, a right rear channel, a bass channel, etc. Through the input and output of audio under pairing of multiple channels, apparatus 300 for reproducing sound can achieve a sound reproduction effect of a stereo sound field with high music quality.

As shown in FIG. 4, isolation switch 410 is configured as one or more two-way switches 412-1, 412-2, . . . , 412-N, two ways in each of two-way switches 412-1, 412-2, . . . , 412-N are used to control a pair of first audio sub-signals SS1-1/GND, SS1-2/GND, . . . , SS1-N/GND, and one or more two-way switches 412-1, 412-2, . . . , 412-N control one or more pairs of audio sub-signals SS1-1/GND, SS1-2/GND, . . . , SS1-N/GND at the same time. Specifically, two-way switches 412-1, 412-2, . . . , 412-N each may include two input ports and two output ports respectively for inputting or outputting any pair of one or more audio sub-signals SS1-1/GND, SS1-2/GND, . . . SS1-N/GND, respectively. In FIG. 4, the connection mode of the outputs of the first audio sub-signals from the two-way switches and the outputs of the second audio sub-signals from wireless communication component 420, and connection and control modes of the two-way switches, the wireless communication component, and the audible sub-components all may refer to the content illustrated in FIG. 3. With the setting of a plurality of two-way switches 410, on or off of the audio signals may be realized using the plurality of two-way switches. The two-way switches may be configured to flexibly control pairs of audio signals. The two-way switches are readily available and facilitate expansion of the apparatus for reproducing sound, achieving a better effect of audio reproduction.

With the specific embodiments of apparatuses 200, 300, 400 for reproducing sound in FIG. 2 to FIG. 4, it can be seen that the apparatuses for reproducing sound achieve reproduction of sound with lower noise, higher sound quality, etc. may be realized by utilizing existing isolation switches to achieve transmission of both types of audio signals, even without arranging the reference level conversion component such as the power amplifier.

FIG. 5 shows a schematic diagram of the headphone 50 having an apparatus for reproducing sound according to the present disclosure. As an example, FIG. 5 illustrates a schematic diagram of the headphone 50. The headphone 50 may include a left loudspeaker L, a right loudspeaker R, and a connector C connected to an audio device. Specifically, the connector C may include, but is not limited to, 6.35 mm, 3.5 mm TRS, 3.5 mm TRRS, 2.5 mm TRRS, 4.4 mm, lightning, USB type-C, 4-pin XLR and possible future plug forms.

It should be noted that possible implementations of the described apparatus are described herein, and other implementations are possible. Furthermore, aspects from two or more of the apparatus may be combined.

Clause 1. In some embodiments, an apparatus for reproducing apparatus includes an isolation switch configured to receive a first audio signal with reference to a first reference level and selectively output or isolate the first audio signal; a wireless communication component configured to wirelessly receive a wireless input signal and to generate and output a second audio signal with reference to a second reference level based on the wireless input signal, where the second reference level is different from the first reference level; and an audible component connected to the isolation switch and the wireless communication component, respectively, and configured to receive, based on determining a state of the isolation switch and a mode of the wireless communication component, one of the first audio signal from the isolation switch or the second audio signal from the wireless communication component and to emit a sound signal based on the received audio signal so that the second audio signal and the first audio signal do not interfere with each other.

Clause 2. According to the apparatus for reproducing sound as in clause 1, that receiving, based on determining a state of the isolation switch and a mode of the wireless communication component, one of the first audio signal from the isolation switch or the second audio signal from the wireless communication component and emitting a sound signal based on the received audio signal includes: based on determining that the isolation switch is turned on and the wireless communication component is powered off, the isolation switch outputting the first signal to the audible component, and the audible component receiving the first audio signal and emitting a first sound signal based on the first audio signal; and based on determining that the isolation switch is turned off and the wireless communication component is powered on, the isolation switch isolating the first audio signal and the wireless output component outputting the second audio signal to the audible component, and the audible component receiving the second audio signal and emitting a second sound signal based on the second audio signal.

Clause 3. According to the apparatus for reproducing sound as in clause 1 or 2, the isolation switch is turned on when its power supply is not driven, and the isolation switch is turned off when the power supply is driven.

Clause 4. According to the apparatus for reproducing sound in any of clauses 1 to 3, the first audio signal includes one or more pairs of first audio sub-signals, each pair of the one or more pairs of first audio sub-signals having an audio signal with reference to the first reference level and a ground signal acting as the first reference level; the second audio signal includes one or more pairs of second audio sub-signals, each pair of the one or more pairs of second audio sub-signals having a positive and negative audio signal with reference to the second reference level; and the audible component includes one or more audible sub-components.

Clause 5. According to the apparatus for reproducing sound in any of clauses 1 to 4, the isolation switch is configured as one or more two-way switches, and two ways in each of the one or more two-way switches either output a pair of first audio sub-signals to the audible sub-component corresponding to the pair of first audio sub-signals or isolate the pair of first audio sub-signals, and the one or more two-way switches either output or isolate the one or more audio sub-signals at the same time.

Clause 6. According to the apparatus for reproducing sound in any of clauses 1 to 5, in case the first audio signal includes two pairs of first audio sub-signals, the isolation switch is configured as a four-way switch, and any two ways of the four-way switches either output a pair of first audio sub-signals to the audible sub-component corresponding to the pair of first audio sub-signals or isolate the pair of first audio sub-signals.

Clause 7. According to the apparatus for reproducing sound in any of clauses 1 to 6, the isolation switch has a power-on duration shorter than a power-on duration of the wireless communication component.

Clause 8. According to the apparatus for reproducing sound in any of clauses 1 to 7, the isolation switch has an isolation voltage value depending on a voltage amplitude of the first audio signal.

Clause 9. According to the apparatus for reproducing sound in any of clauses 1 to 8, the wireless communication component is directly connected to the audible component without arranging a conversion component for converting the second audio signal with reference to the second reference level to a further audio signal with reference to the first reference level.

Clause 10. In some embodiments, a headphone includes the apparatus for reproducing sound of any one of clauses 1 to 9.

It should be noted that clauses 1 to 10 may be combined with any of the features or clauses discussed elsewhere in this application.

Although various embodiments for implementing the present invention have been disclosed, those skilled in the art can understand that a variety of variations and modifications to these embodiments can be made without departing from the principles and spirit of the present invention, thereby realizing some of the advantages of the present invention. It is apparent to those skilled in the art that other components performing the same functions may be appropriately substituted. These modifications to the concepts of the present invention should also be included within the scope of the appended claims.

What is claimed is:

1. An apparatus for reproducing sound comprising:
an isolation switch configured to receive a first audio signal with reference to a first reference level and selectively output or isolate the first audio signal;
a wireless communication component configured to wirelessly receive a wireless input signal and to generate and output a second audio signal with reference to a second reference level based on the wireless input signal, wherein the second reference level is different from the first reference level; and
an audible component connected to the isolation switch and to the wireless communication component, respectively, and the audible component is configured to receive, based on determining a state of the isolation switch and a mode of the wireless communication component, one of the first audio signal from the isolation switch or the second audio signal from the wireless communication component and to emit a sound signal based on the received audio signal so that the second audio signal and the first audio signal do not interfere with each other.

2. The apparatus for reproducing sound of claim 1, wherein the audible component receives, based on determining a state of the isolation switch and a mode of the wireless communication component, one of the first audio signal from the isolation switch or the second audio signal from the wireless communication component and emits a sound signal based on the received audio signal comprises:
based on determining that the isolation switch is turned on and the wireless communication component is powered off, the isolation switch outputting the first signal to the audible component, and the audible component receiving the first audio signal and emitting a first sound signal based on the first audio signal; and
based on determining that the isolation switch is turned off and the wireless communication component is powered on, the isolation switch isolating the first audio signal and the wireless output component outputting the second audio signal to the audible component, and the audible component receiving the second audio signal and emitting a second sound signal based on the second audio signal.

3. The apparatus for reproducing sound of claim 1, wherein,
the isolation switch is turned on when a power supply of the isolation switch is not driven, and the isolation switch is turned off when the power supply of the isolation switch is driven.

4. The apparatus for reproducing sound of claim 1, wherein,
the first audio signal comprises one or more pairs of first audio sub-signals, each pair of the one or more pairs of first audio sub-signals having an audio signal with reference to the first reference level and a ground signal acting as the first reference level;
the second audio signal comprises one or more pairs of second audio sub-signals, each pair of the one or more pairs of second audio sub-signals having a positive and negative audio signal with reference to the second reference level; and
the audible component comprises one or more audible sub-components.

5. The apparatus for reproducing sound of claim 4, wherein,
the isolation switch is configured as one or more two-way switches, and two ways in each of the one or more two-way switches either output a pair of first audio sub-signals to the audible sub-component corresponding to the pair of first audio sub-signals or isolate the pair of first audio sub-signals, and the one or more two-way switches either output or isolate the one or more audio sub-signals at the same time.

6. The apparatus for reproducing sound of claim 4, wherein,
in response to the first audio signal having two pairs of first audio sub-signals, the isolation switch is configured as a four-way switch, and any two way switches of the four-way switches either output a pair of first audio sub-signals to the audible sub-component corresponding to the pair of first audio sub-signals or isolate the pair of first audio sub-signals.

7. The apparatus for reproducing sound of claim 1, wherein the isolation switch has a power-on duration shorter than a power-on duration of the wireless communication component.

8. The apparatus for reproducing sound of claim 1, wherein the isolation switch has an isolation voltage value depending on a voltage amplitude of the first audio signal.

9. The sound reproduction apparatus of claim 1, wherein the wireless communication component is directly connected to the audible component without arranging a reference level conversion component for converting the second audio signal with reference to the second reference level to a further audio signal with reference to the first reference level.

10. A headphone, comprising the apparatus for reproducing sound of claim 1.

11. A headphone for reproducing sound comprising:
an isolation switch configured to receive a first audio signal associated to a first reference level and selectively output or isolate the first audio signal;
a wireless communication component configured to wirelessly receive a wireless input signal and to generate and output a second audio signal associated to a second reference level based on the wireless input signal, wherein the second reference level is different from the first reference level; and
an audible component connected to the isolation switch and to the wireless communication component, respectively, and the audible component is configured to receive, based on determining a state of the isolation switch and a mode of the wireless communication component, one of the first audio signal from the isolation switch or the second audio signal from the wireless communication component and to emit a sound signal based on the received audio signal so that the second audio signal and the first audio signal do not interfere with each other.

12. The headphone for reproducing sound of claim 11, wherein the audible component receives, based on determining a state of the isolation switch and a mode of the wireless communication component, one of the first audio signal from the isolation switch or the second audio signal from the wireless communication component and emits a sound signal based on the received audio signal comprises:
based on determining that the isolation switch is turned on and the wireless communication component is powered off, the isolation switch outputting the first signal to the audible component, and the audible component receiving the first audio signal and emitting a first sound signal based on the first audio signal; and
based on determining that the isolation switch is turned off and the wireless communication component is powered on, the isolation switch isolating the first audio signal and the wireless output component outputting the second audio signal to the audible component, and the audible component receiving the second audio signal and emitting a second sound signal based on the second audio signal.

13. The apparatus for reproducing sound of claim 11, wherein,
the isolation switch is turned on when a power supply of the isolation switch is not driven, and the isolation switch is turned off when the power supply of the isolation switch is driven.

14. The apparatus for reproducing sound of claim 11, wherein,
the first audio signal comprises one or more pairs of first audio sub-signals, each pair of the one or more pairs of first audio sub-signals having an audio signal with reference to the first reference level and a ground signal acting as the first reference level;
the second audio signal comprises one or more pairs of second audio sub-signals, each pair of the one or more pairs of second audio sub-signals having a positive and negative audio signal with reference to the second reference level; and
the audible component comprises one or more audible sub-components.

15. The apparatus for reproducing sound of claim 14, wherein,
the isolation switch is configured as one or more two-way switches, and two ways in each of the one or more two-way switches either output a pair of first audio sub-signals to the audible sub-component corresponding to the pair of first audio sub-signals or isolate the pair of first audio sub-signals, and the one or more two-way switches either output or isolate the one or more audio sub-signals at the same time.

16. The apparatus for reproducing sound of claim 14, wherein,
in response to the first audio signal having two pairs of first audio sub-signals, the isolation switch is configured as a four-way switch, and any two way switches of the four-way switches either output a pair of first audio sub-signals to the audible sub-component corresponding to the pair of first audio sub-signals or isolate the pair of first audio sub-signals.

17. The apparatus for reproducing sound of claim 11, wherein the isolation switch has a power-on duration shorter than a power-on duration of the wireless communication component.

18. The apparatus for reproducing sound of claim 11, wherein the isolation switch has an isolation voltage value depending on a voltage amplitude of the first audio signal.

19. The sound reproduction apparatus of claim 11, wherein the wireless communication component is directly connected to the audible component without arranging a reference level conversion component for converting the second audio signal with reference to the second reference level to a further audio signal with reference to the first reference level.

20. An apparatus for reproducing sound comprising:
an isolation switch configured to receive a first audio signal associated to a first reference level and selectively output or isolate the first audio signal;
a first communication component configured to receive an input signal and to generate and output a second audio signal associated to a second reference level based on the input signal, wherein the second reference level is different from the first reference level; and
an audible component connected to the isolation switch and to the first communication component, respectively, and the audible component is configured to receive, based on determining a state of the isolation switch and a mode of the first communication component, one of the first audio signal from the isolation switch or the second audio signal from the first communication component and to emit a sound signal based on the received audio signal so that the second audio signal and the first audio signal do not interfere with each other.
